(19) United States
(12) Patent Application Publication
(10) Pub. No.: US 2022/0069373 A1
(43) Pub. Date: Mar. 3, 2022

(54) PTC Sensing Circuit for Lithium Ion Battery Arrays

(71) Applicant: Manaflex, LLC, Waikoloa, HI (US)

(72) Inventor: Robert Clinton Lane, Waikoloa, HI (US)

(21) Appl. No.: 17/464,636

(22) Filed: Sep. 1, 2021

Related U.S. Application Data
(60) Provisional application No. 63/072,950, filed on Sep. 1, 2020.

(51) Int. Cl. H01M 10/48; H01M 10/42; G01K 7/22

(52) U.S. Cl. CPC H01M 10/486; G01K 7/22; H01M 10/425

(57) ABSTRACT

A PTC sensing circuit formed on a substrate offering an easily assembled solution to detect thermal runaway event in a group of battery cells. Various circuit designs are contemplated. Optionally this sensing circuit can work with or be part of the cell interconnect in a battery module. It can also be part of the collector.

### FIELD OF THE DISCLOSURE

The present disclosure relates to a component in a lithium ion battery module and, more particularly, a sensing circuit for a lithium ion battery module.

### BACKGROUND OF THE DISCLOSURE

Generally, using a PTC (positive temperature coefficient) material as a temperature sensor in an array of battery cells is known, see for example, U.S. Pat. No. 6,444,350, which is herein incorporated by reference in its entirely.

It is known that sensing the temperature of battery cells in a lithium ion battery module is important to determine the charge/discharge rates, the cooling rates, and the general health of the battery module. Currently, however, there are no effective ways to detect the true health of every battery cell out of the hundreds or thousands of battery cells in a lithium ion battery back/battery module. It is difficult to detect which battery cell is defective, damaged, or is undergoing thermal runaway.

It is important to know which battery cell is defective because one defective battery cell will affect the life of the entire battery module. Oftentimes when one battery cell becomes defective, it impacts all other battery cells in series within the same brick.

There is a continuing need for new ways to detect and monitor the health of a battery module.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 illustrates plan top views of various layers of material of a contemplated PTC sensing circuit according to an aspect of the disclosure.

FIG. 2 is a close-up top plan view of a portion of the metal conductive layer without the PTC carbon ink according to one contemplated embodiment.

FIG. 3 is a close-up top plan view of a portion of the metal conductive layer of FIG. 2 with the PTC carbon ink overlay, according to an aspect of the disclosure.

FIG. 4 illustrates the various layers of one embodiment of the PTC sensing circuit, according to an aspect of the disclosure.

FIG. 5 illustrates the various layers of one embodiment of the PTC sensing circuit in relation with two adjacent battery cells, according to an aspect of the disclosure.

FIG. 6 illustrates a circuit of one embodiment of the PTC sensing circuit, according to an aspect of the disclosure.

FIG. 7 is a close-up top plan view of a portion of the metal conductive layer in another embodiment without the PTC carbon ink, according to an aspect of the disclosure.

FIG. 8 is a close-up top plan view of a portion of the metal conductive layer of FIG. 6 with the PTC carbon ink overlay, according to an aspect of the disclosure.

### DESCRIPTION OF THE EMBODIMENTS

The different aspects of the various embodiments can now be better understood by turning to the following detailed description of the embodiments, which are presented as illustrated examples.

In one embodiment, the contemplated method can provide spontaneous feedback that a battery pack, a battery module, and/or at least one battery cell has been compromised due to a thermal runaway event. The contemplated method can also provide a higher resolution temperature of the battery module as a whole through a single data point.

In another embodiment, a multi-layer circuit is provided to detect a rise in temperature in a group of battery cells.

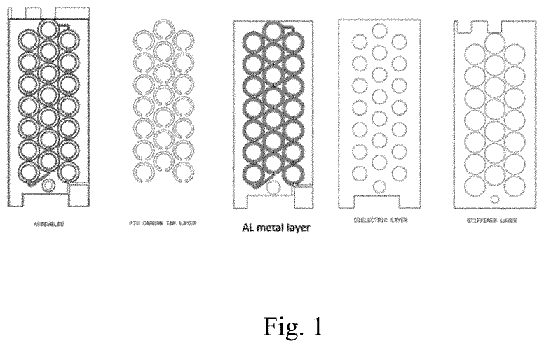

Referring to FIG. 1, the various layers in this multi-layer circuit is shown. Here, a pattern of PTC carbon ink is provided for every battery cell. One skilled in the art would see the possibility of designing different patterns of such PTC carbon ink to be placed on the top of a battery cell rim, on the bottom of a battery cell, and/or even on the side of a battery cell. The contemplated solution can be used for cylindrical battery cells as well as for other shapes and configurations of battery cells such as pouch cells.

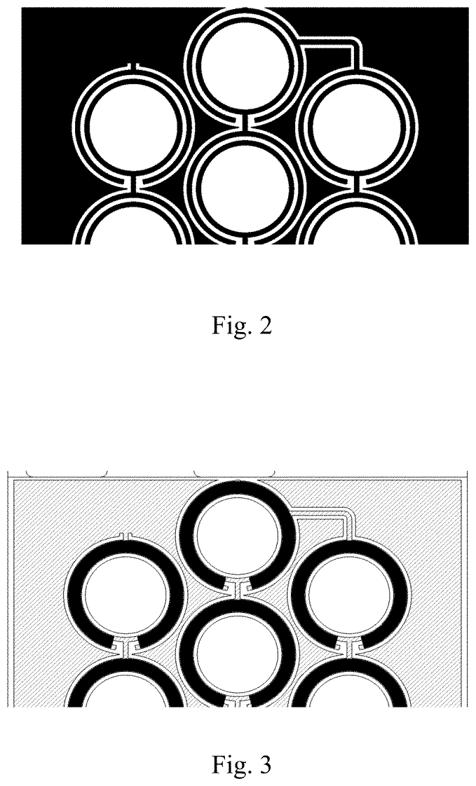

As mentioned above, the contemplated PTC ink can be used in a pattern that makes an indirect contact with every battery cell with a dielectric layer being in between the PTC ink and the battery cell. The pattern can be a single circuit that is composed of an aluminum portion and a PTC carbon ink portion where there are PTC joints at every cell location that makes an indirect contact the battery cell. As shown in FIGS. 2 and 3, each of these PTC patterns is in series and the entire circuit of many battery cells creates a resistance simultaneously at a given temperature globally and locally.

FIG. 2 shows the pattern of the metal layer. All darkened area is the metal layer. All empty space can be just empty space, creating breaks in this illustrated circuit in series. This break can be some kind of dielectric gap. In particular, there is shown a break between an inner circle and its corresponding outer circle.

FIG. 3 shows a pattern of PTC carbon ink layer (darkened areas) applied across the breaks, bridging the gaps. The area of shaded lines represents the metal layer which was shown as dark regions in FIG. 2. In a PTC material, an increase in temperature also increases the resistance of the PTC material. Since the PTC ink has a high resistance at room temperature (10 kohm/square), a pattern can be created that reduces the resistance by parallelizing the squares for each location and then stacking them in series to obtain a total resistance that is measurable.

In one embodiment, the design requires no heat conducting. There need not be a heat conductor attached to each battery cell.

In another embodiment, each of the dark circles correspond to each battery cell. That is, the circular shaped PTC ink corresponds to the circumference of the top rim of each battery cell.

In another embodiment, each dark circle can be designed to have a different width and/or thickness such that the resistance can be different from one dark circle to another. In this way, a characteristic resistance profile can be created for each battery cell location. By changing the geometry of the ring (e.g., the resistance lowers when it is a larger/wider ring), a characteristic resistance can be assigned to a particular ring/battery cell. When there is a large change in resistance the system can detect which battery cell is misbehaving.

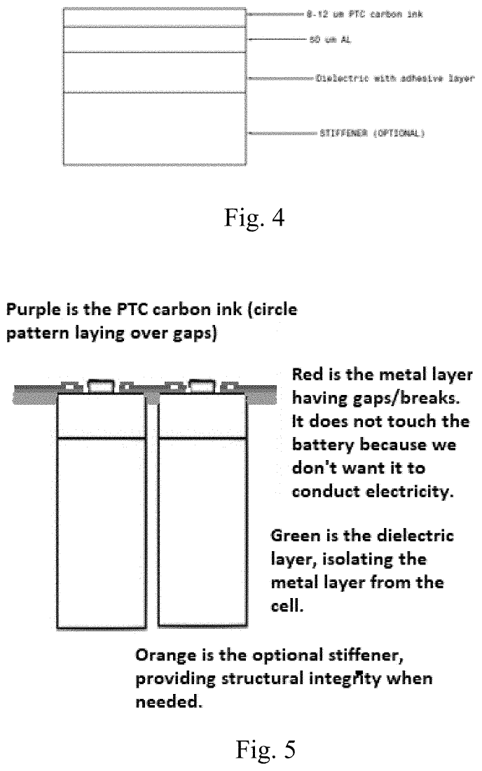

FIG. 4 illustrates one embodiment where the PTC layer is applied on top of the metal conductive layer. It should be noted that the PTC layer can also be applied below the conductive layer so long as there is another dielectric layer above the metal layer to support the metal layer. The dielectric layer can electrically insulate the metal layer from the battery cells.

The metal layer should be as thin as possible. In one embodiment, 50 um is used, but the disclosure is not limited thereto. In other embodiments, it can be 10 um or even thinner, but the disclosure is not limited thereto. Then the metal layer is put on the dielectric layer which can be a PET or PI or any suitable dielectric support. This circuit can then be applied onto a stiffening layer which is optional.

FIG. 5 illustrates the multi-layer structure of FIG. 4 in relation with two adjacent battery cells. Here, the bottommost layer is an optional layer of stiffener. The optional stiffener layer can have circular holes to fit each battery cells. Note the stiffener layer here does not touch the top side of the battery cells. Above the stiffener layer is the dielectric layer to isolate the metal layer from the battery cell. The dielectric layer touches the top side of the battery cells. Above the dielectric layer is the metal layer such as that shown in FIG. 2. Above the metal layer is the PTC layer such as that shown in FIG. 3.

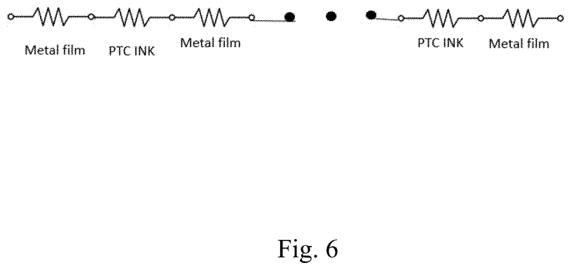

FIG. 6 illustrates a simplified diagram to show that the circuit alternates from metal to PTC ink from the positive to the negative end. The metal can have very low resistance of less than 1 ohm; the PTC link can be approximately 10,000 ohm divided by the number of battery cells put in parallel or whatever measurable resistance divided by number of battery cells.

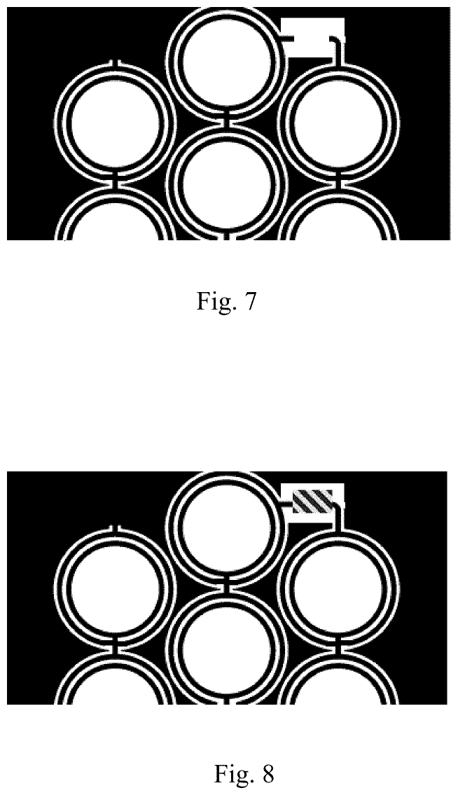

FIG. 7 is another example of applying the same principle in designing a metal layer circuit with breaks. Here, there are no breaks between an inner circle and its corresponding outer circle. Instead, there is a break created from one outer circle to an adjacent outer circle. In FIG. 8, a PTC carbon ink layer (area in shaded lines) is applied across the break of FIG. 7. This is a simplified example to show that a break and its corresponding PTC layer may be applied in areas other than that shown in FIGS. 2 and 3. One skilled in the art would recognize the need to tweak the location and surface areas of the PTC layer for a particular design to work.

One contemplated method of manufacturing:
1. Aluminum circuit is patterned (another patent) onto a substrate using reel to reel manufacturing.
2. Then the carbon PTC ink which is pre silk screened in a pattern on a PET liner is applied to this aluminum pattern on a reel to reel process
3. Then a thermally conductive PSA is laminated as well on a reel to reel process.
   One contemplated geometry design:
1. The Carbon is on the crimp (rim) of the cell. For a lot of single sided interconnects that weld here this is valuable to know the temperature at this point
2. The circuit is made such that there is a large opening for the cell interconnects which allows the cell to top vent
3. The circuit is made in such a way to create a 10 kOHM structure based on a 15 kohm/square PTC.
4. The circuit is made in such a way that it can be applied to the cell interconnect in a multilayer FPC.

Many alterations and modifications may be made by those having ordinary skill in the art without departing from the spirit and scope of the disclosed embodiments.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure.

What is claimed is:

1. A battery module comprising:
a housing;
a plurality of bricks electrically connected and disposed in the housing;
a plurality of battery cells electrically connected and disposed in an array to form a brick in said plurality of bricks;
a cell interconnect coupled to the plurality of battery cells in said brick;
a sheet of sensing circuit disposed either on a top or on a bottom of the plurality of cells, said sheet of sensing circuit includes:
a) a metal conductive layer having a pattern and the pattern has a least one gap;
b) a PTC (positive temperature coefficient) layer disposed across said at least one gap to allow a plurality of electrons to flow via a path in the metal conductive layer and bypassing the at least one gap.

2. The battery module as recited in claim 1, wherein an increase in temperature in at least one of the plurality of battery cells in said brick causes a measurable increase of resistance in said sheet of sensing circuit.

3. The battery module as recited in claim 2, wherein the path includes an arrangement in series in a cell-by-cell configuration within said brick.

4. The battery module as recited in claim 2 further comprising a dielectric layer disposed between the metal conductive layer and said plurality of batteries to prevent said metal conductive layer to directly touch the plurality of batteries.

5. The battery module as recited in claim 6, wherein the dielectric layer is part of said sheet of sensing circuit.

6. The battery module as recited in claim 6, wherein the PTC layer is comprised of a PTC carbon ink.

7. The battery module as recited in claim 6, wherein said sheet of sensing circuit is disposed on the top of the plurality of battery cells where potential venting could take place.

8. The battery module as recited in claim 6, wherein the PTC layer includes a plurality of circular shaped-ink, and each of said plurality of circular shaped-ink corresponds in relative position and dimension with a circular crimp rim of one of said plurality of battery cells.

9. The battery module as recited in claim 8 further comprising a stiffener layer within said sheet of sensing circuit.

10. A method of spontaneously detecting a thermal runaway event in a battery module, the method comprising:
providing a battery module having an array of lithium ion battery cells to form a brick, and a plurality of liked bricks are connected to form a module;
providing a sheet of sensing circuit in close proximity with said plurality of battery cells in said brick, wherein the sheet of sensing circuit has a metal conductive layer and a dielectric layer; and
wherein the dielectric layer prevents the metal conductive layer from directly touching the plurality of battery cells;
monitoring and measuring a change in a resistance of the metal conductive layer;
sending an alert when the resistance has increased above a threshold level.

11. The method as recited in claim 9 further comprising a pattern in the metal conductive layer, and the pattern has at least one break.

12. The method as recited in claim 10 further comprising applying a PTC (positive temperature coefficient) material across the at least one break such that a thermal runaway event would cause a measurable change in the resistance of the metal conductive layer.

13. The method as recited in claim 13 further comprising using a reel-to-reel machine to produce and laminate together at least the following layers to form a flexible printed circuit: the metal conductive layer, the dielectric layer, and the PTC material.
